(19) United States
(12) Patent Application Publication
(10) Pub. No.: US 2012/0237813 A1
(43) Pub. Date: Sep. 20, 2012

(54) BATTERY COVER ASSEMBLY FOR ELECTRONIC DEVICES

(75) Inventors: ZHENG SHI, Shenzhen City (CN); GUO-WU JIANG, Shenzhen City (CN)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 13/240,298

(22) Filed: Sep. 22, 2011

(30) Foreign Application Priority Data
Mar. 14, 2011 (CN) 201110060621.5

(51) Int. Cl. H01M 2/10

(52) U.S. Cl. 429/100

(57) ABSTRACT

A battery cover assembly for an electronic device includes a main body and a battery cover detachably attached to the main body. The main body includes at least one latching portion, at least one opening, and an engagement portion adjacent to the at least one opening. The battery cover includes at least one protrusion, at least one extending block and a retaining member adjacent to the at least one extending block. The at least one protrusion is slidably latched with the at least one latching portion. The at least one extending block engages into the at least one opening, and the retaining member is pressed to assembled with the engagement portion.

### CROSS-REFERENCE TO RELATED APPLICATIONS

This application is related to co-pending U.S. patent application Ser. No. ______ (Attorney Docket No.US37118), entitled “BATTERY COVER ASSEMBLY FOR ELECTRONIC DEVICES”, by Shi et al. The application has the same assignee as the present application and has been concurrently filed herewith. The above-identified applications are incorporated herein by reference.

### BACKGROUND

1. Technical Field

The present disclosure generally relates to battery cover assemblies and electronic devices using the same.

2. Description of Related Art

Batteries are widely used in electronic devices, such as personal digital assistants, mobile phones, and so on. Generally, batteries are received in the electronic device, and a battery cover is assembled with a housing of the electronic device to protect the batteries. When the batteries are damaged and/or dead, the battery cover is opened to replace the batteries. However, a typical battery cover is inconvenient to disassemble from the housing of the electronic device.

Therefore, there is a room for improvement within the art.

### BRIEF DESCRIPTION OF THE DRAWINGS

Many aspects of the present battery cover assemblies and electronic devices using the same can be better understood with reference to the following drawings. The components in the drawings are not necessarily to scale, the emphasis instead being placed upon clearly illustrating the battery cover assemblies and electronic devices using the same. Moreover, in the drawings, like reference numerals designate corresponding parts throughout the several views.

FIG. 1 is a schematic view of a battery cover assembly according to an exemplary embodiment.

FIG. 2 is similar to FIG. 1, but shown from another angle.

FIG. 3 is a schematic view of a main body of the battery cover assembly shown in FIG. 1.

FIG. 4 is an enlarged view of a circular area IV shown in FIG. 3.

FIG. 5 is a schematic view of a battery cover of the battery cover assembly shown in FIG. 1.

FIG. 6 is a schematic view of a retaining member of the battery cover shown in FIG. 5.

FIG. 7 is an assembled view of the battery cover assembly shown in FIG. 1.

FIG. 8 is an enlarged view of a circular area VIII shown in FIG. 7.

### DETAILED DESCRIPTION

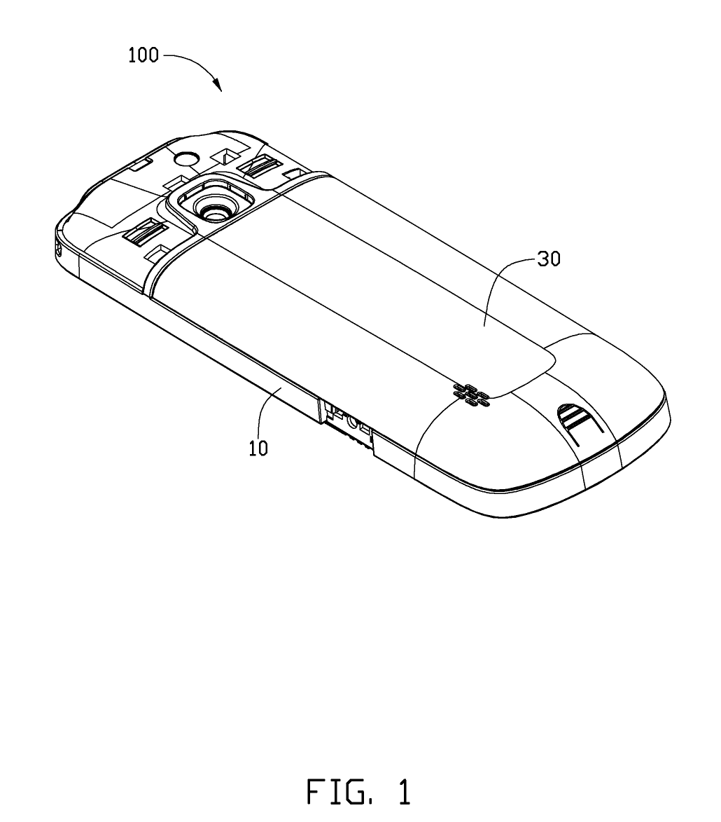

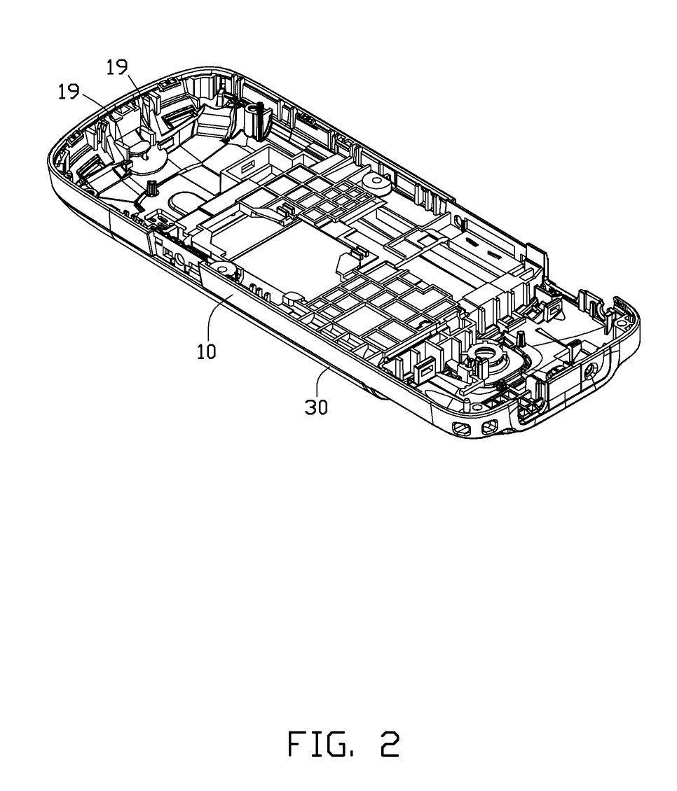

FIGS. 1 and 2 show an electronic device, such as a mobile phone, employing a battery cover assembly 100. The mobile phone is an exemplary application, for the purposes of describing details of an exemplary embodiment of the battery cover assembly 100. The battery cover assembly 100 includes a main body 10 and a battery cover 30 detachably attached to the main body 10.

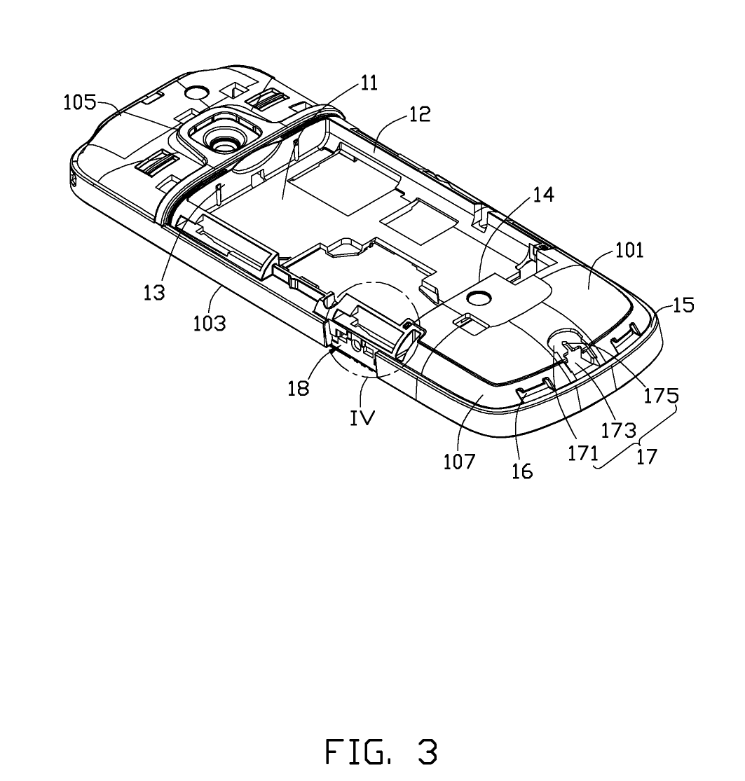

Referring to FIG. 3, the main body 10 includes an outer surface 101 and an inner surface 103 opposite to the outer surface 101. The outer surface 101 defines a receiving chamber 11 for receiving a battery of the electronic device 100. One end of the outer surface 101 includes a first end portion 105, and one opposite end of the outer surface 101 includes a second end portion 107.

The receiving chamber 11 includes two opposite sidewalls 12, a first end wall 13, and a second end wall 14 opposite to the first end wall 13. Each sidewall 12 is connected to the first end wall 13 and the second end wall 14. Peripheral edges of the first end wall 13, the two sidewalls 12, and the second end portion 107 provide a mating surface 15 for engaging with an inner surface of the battery cover 30. The mating surface 15 is lower than the outer surface 101. Two spaced openings 16 and an engagement portion 17 are defined on the second end portion 107. The engagement portion 17 defines a notch 171, a through groove 173, and a guiding slot 175 in communication with the through groove 173. Referring to FIG. 2, two opposite side projections 19 adjacent to the through groove 173 are located on the inner surface 103. The two side projections 19 are spaced from each other by the through groove 173.

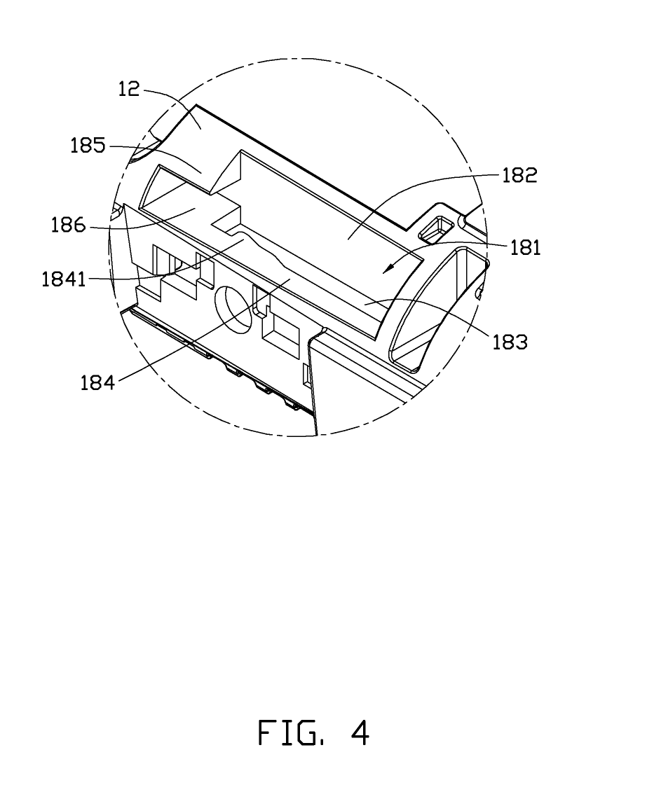

Referring to FIG. 4, each sidewall 12 defines two latching portions 18 spaced from each other. Each latching portion 18 defines a receiving slot 181 and has a stopping block 185 positioned at a corner of the receiving slot 181. The receiving slot 181 is surrounded by a first resisting wall 182 and a second resisting wall 184 substantially perpendicular to the first resisting wall 182. The second resisting wall 184 defines a containing slot 183 communicating with the receiving slot 181. A resisting portion 1841 parallelly extends from the second resisting wall 184 and is substantially perpendicularly to the first resisting wall 182. The resisting portion 1841 is made of a resilient material such as rubber. A receiving cavity 186 is defined by the stopping block 185 and the second resisting wall 184.

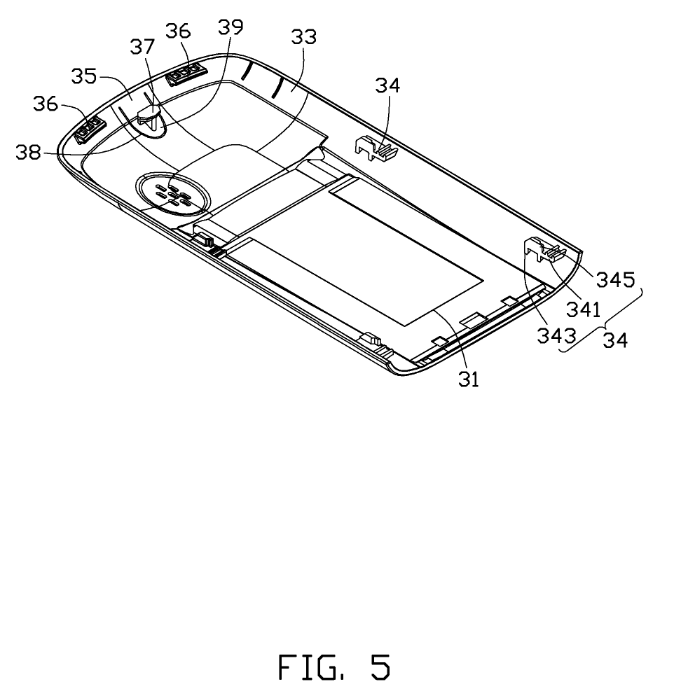

Referring to FIG. 5, the battery cover 30 includes a main portion 31, two opposite side plates 33 extending from lateral edges of the main portion 31, and an end plate 35 extending from a top edge of the main portion 31 to connect together the two opposite side plates 33. Two spaced protrusions 34 are located on each side plate 33. Each protrusion 34 includes a base portion 341, two support portions 343, and a latching projection 345 substantially perpendicularly protruding from a side of the base portion 341. The base portion 341 is substantially perpendicularly located on the side plate 33, and is substantially parallel with the main portion 31. The base portion 341 can slidably engage within the receiving cavity 186. The two support portions 343 are located on the side plate 33 for supporting the base portion 341. Each of the latching projections 345 can slidably engage within the corresponding containing slot 183, respectively.

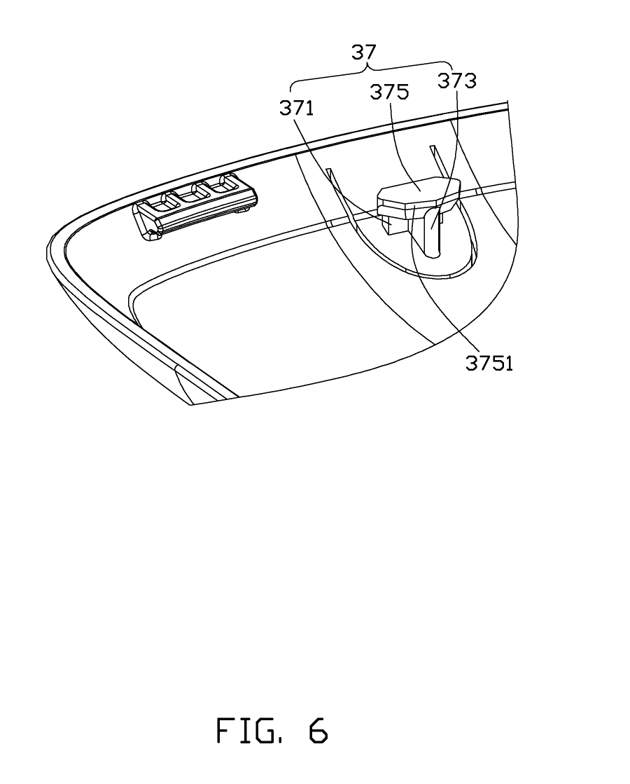

Two extending blocks 36 are formed on the end plate 35. A slot 38 is defined in the main portion 31 and the end plate 35, and a movable plate 39 is formed in the slot 38. The slot 38 is substantially U-shaped. A retaining member 37 is positioned on the movable plate 39. Referring to FIG. 6, the retaining member 37 includes a base plate 371, a support plate 373, and a top plate 375. The base plate 371 is secured on the movable plate 39. The support plate 373 is perpendicularly connected with the base plate 371 and the movable plate 39. The top plate 375 is secured on the base plate 371 and the support plate 373. Sidewalls of the top plate 375 define two guiding surfaces 3751.

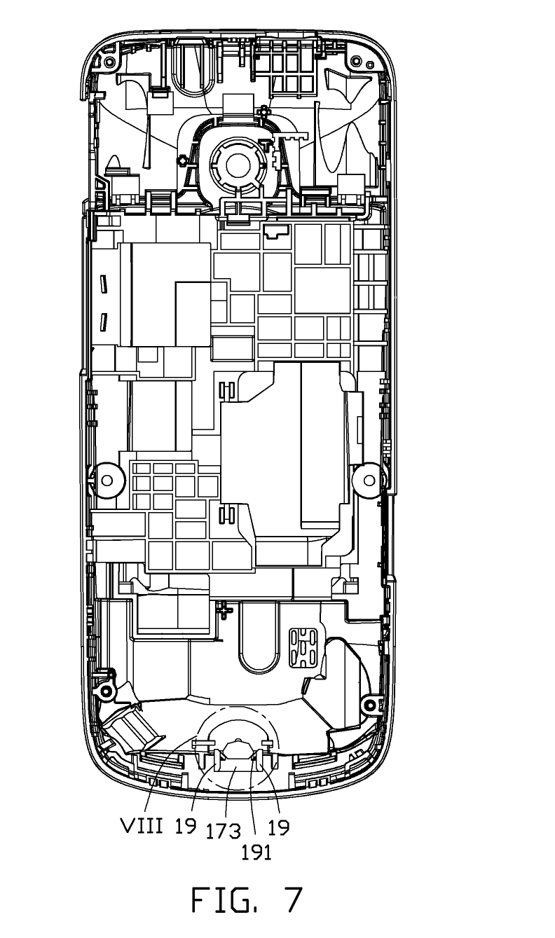

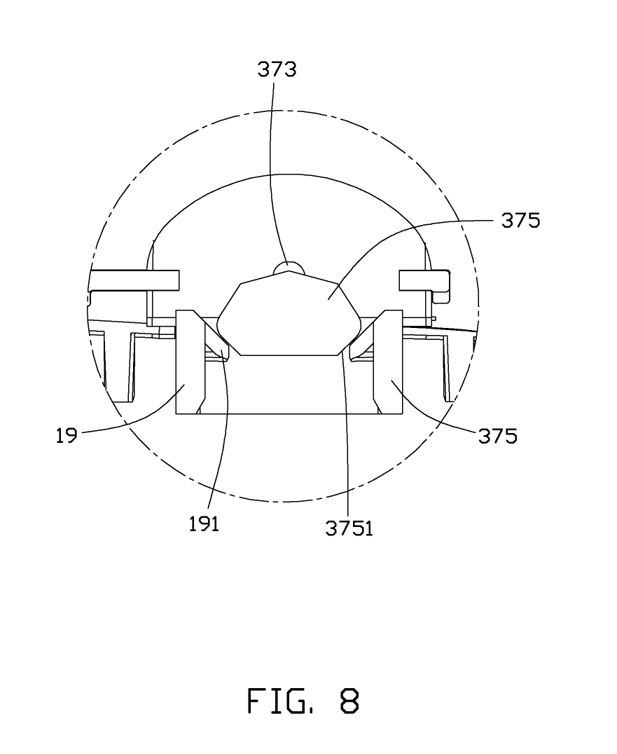

Referring to FIGS. 7 and 8, the assembly process of the electronic device 100 may be described as follows:

The battery cover 30 abuts against the mating surface 15 of the main body 10. Each latching projection 345 is received in the corresponding containing slot 183. Meanwhile, the extending blocks 36 are aligned with the openings 16, and the retaining member 37 is aligned with the through groove 173.

Each side projection 19 includes a stopper portion 191 protruding toward the other side projection 19. In this embodiment, the stopper portion 191 is substantially a triangular prism. The battery cover 30 is pushed towards the first end portion 105, and the movable plate 39 is pressed towards the main body 10. The top plate 375 and the stopper portions 191 are staggered to allow the top plate 375 to pass over the stopper portions 191. Meanwhile, the latching projection 345 abuts against the resisting portion 1841, the resisting portion 1841 is deformed to allow the latching projection 345 to pass over the resisting portion 1841, and the support plate 373 is received in the guiding slot 175. Then, the movable plate 39 is released and bounces back to allow each stopper portion 191 to abut against one guiding surface 3751. Accordingly, the battery cover 30 is assembled to the main body 10.

The disassembly process of the electronic device 100 may be described as follows: the movable plate 39 is pressed towards the main body 10 and the battery cover 30 is pushed towards the second end portion 107. The top plate 375 and the stopper portions 191 are staggered to allow the top plate 375 to disassemble from the two side projections 19, and the resisting portion 1841 is deformed to allow the latching projection 345 to pass over the resisting portion 1841. The battery cover 30 is further pushed towards the second end portion 107, the extending block 36 is disassembled from the opening 16, and the support plate 373 is disassembled from the guiding slot 175. Accordingly, the battery cover 30 is disassembled from the main body 10.

The battery cover 30 can conveniently assembled and disassembled.

In another exemplary embodiment, there is only one protrusion 34, one extending block 36, one opening 16, and one latching portion 18.

It is to be understood, however, that even through numerous characteristics and advantages of the present disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A battery cover assembly for an electronic device, comprising:
a main body comprising at least one latching portion, at least one opening and an engagement portion adjacent to the at least one opening; and
a battery cover detachably attached to the main body, the battery cover comprising at least one protrusion, at least one extending block and a retaining member adjacent to the at least one extending block;
wherein the at least one protrusion is slidably latched with the at least one latching portion, the at least one extending block engages into the at least one opening, and the retaining member is pressed to be assembled with the engagement portion.

2. The battery cover assembly as claimed in claim 1, wherein the battery cover further comprises a main portion, two opposite side plates extending from lateral edges of the main portion, and an end plate extending from a top edge of the main portion to connect the two opposite side plates; the at least one protrusion is located on each side plate, the at least one extending block is formed on the end plate, a slot is defined in the main portion and the end plate, and a movable plate is formed in the slot, the retaining member is positioned on the movable plate.

3. The battery cover assembly as claimed in claim 2, wherein the retaining member comprises a base plate and a top plate, the base plate is secured on the movable plate, and the top plate is secured on the base plate.

4. The battery cover assembly as claimed in claim 3, wherein the retaining member further comprises a support plate perpendicularly connected with the base plate and the movable plate.

5. The battery cover assembly as claimed in claim 4, wherein the engagement portion defines a notch, a through groove and a guiding slot in communication with the through groove, the support plate is received in the guiding slot, and the top plate is pressed to pass the through groove and latch on the main body.

6. The battery cover assembly as claimed in claim 5, wherein two opposite side projections adjacent to the through groove are located on an inner surface of the main body, and the two side projections are spaced from each other by the through groove.

7. The battery cover assembly as claimed in claim 6, wherein each side projection comprises a stopper portion protruding toward the other side projection, sidewalls of the top plate define two guiding surfaces, and each stopper portion abuts against one guiding surface.

8. The battery cover assembly as claimed in claim 2, wherein the at least one protrusion comprises a base portion and a latching projection perpendicularly protruding from an edge of the base portion, the base portion is located on the side plate.

9. The battery cover assembly as claimed in claim 8, wherein the at least one latching portion defines a receiving slot and a stopping block positioned at a corner of the receiving slot.

10. The electronic device as claimed in claim 9, wherein the receiving slot is surrounded by a first resisting wall and a second resisting wall substantially perpendicular to the first resisting wall, the second resisting wall defines a containing slot communicating with the receiving slot, and the latching projection is slidably engaged within the containing slot.

11. The electronic device as claimed in claim 10, wherein a resisting portion is formed on the second resisting wall and is perpendicularly extended toward the first resisting wall.

12. The electronic device as claimed in claim 11, wherein a receiving cavity is defined between the stopping block and the second resisting wall, and the base portion is slidably engaged within the receiving cavity.

13. The electronic device as claimed in claim 11, wherein the resisting portion is made of resilient material.

14. An electronic device, comprising:
a main body defining a latching portion, an opening, and a through groove adjacent to the opening; and
a battery cover detachably located on the main body, the battery cover comprises at least one protrusion, at least one extending block and a retaining member,
wherein the at least one protrusion is slid to latch in the at least one latching portion; the retaining member is pressed to pass the through groove and latch on the main body, and the at least one extending block engages into the at least one opening.

15. The electronic device as claimed in claim 14, wherein the battery cover further comprises a main portion, two opposite side plates extending from lateral edges of the main portion, and an end plate extending from a top edge of the main portion to connect the two opposite side plates; the at least one protrusion is located on each side plate, the at least one extending block is formed on the end plate, the main portion and the end plate define a slot to form a movable plate, the retaining member is positioned on the movable plate.

16. The electronic device as claimed in claim 15, wherein the retaining member comprises a base plate and a top plate, the base plate is secured on the movable plate, and the top plate is secured on the base plate.

17. The electronic device as claimed in claim 16, wherein the retaining member further comprises a support plate perpendicularly connected with the base plate, the support plate is perpendicularly secured on the movable plate.

18. The electronic device as claimed in claim 17, wherein a guiding slot in communication with the through groove is defined on the main body, the support plate is received in the guiding slot, and the top plate is pressed to pass the through groove and latch on the main body.

19. The electronic device as claimed in claim 18, wherein two opposite side projections adjacent to the through groove are located on an inner surface of the main body, and the two side projections are spaced from each other by the through groove.

20. The electronic device as claimed in claim 19, wherein each side projection comprises a stopper portion protruding toward the other side projection, sidewalls of the top plate define two guiding surfaces, and each stopper portion abuts against one guiding surface.
